(19) United States
(12) Patent Application Publication
(10) Pub. No.: US 2026/0244386 A1
(43) Pub. Date: Aug. 20, 2026

(54) DEVICE AND METHOD FOR DISPLAY SYNCHRONIZATION

(71) Applicant: Samsung Electronics Co., Ltd., Gyeonggi-do (KR)

(72) Inventors: Kilhyung CHA, San Jose, CA (US); Satyanarayana AVADHANAM, Austin, TX (US); Rajesh SIDANA, Bangalore (IN); Abdul Haseeb ORUVAMPURATH, Bangalore (IN); SangHoon LEE, Seoul (KR); Yon Jun SHIN, Gyeonggi-do (KR); Jong-Hun HAN, Gyeonggi-do (KR)

(21) Appl. No.: 19/402,141

(22) Filed: Nov. 26, 2025

Related U.S. Application Data
(60) Provisional application No. 63/758,575, filed on Feb. 14, 2025.

(51) Int. Cl. G06F 3/14

(52) U.S. Cl. CPC G06F 3/14

(57) ABSTRACT

Systems and methods are disclosed for synchronizing multiple display streams generated by one or more display pipelines. A data processing unit includes a first display pipeline and at least one second display pipeline, each coupled to a corresponding video timer. A first video timer outputs a first synchronization signal to initiate a first display stream and to trigger at least one second video timer. The second video timer generates a second synchronization signal based on the first synchronization signal to initiate a second display stream in phase with the first. By coordinating video timer outputs through selectable synchronization signals, multiple display pipelines can operate in precise temporal alignment to generate synchronized streams through one or more display ports.

### CROSS-REFERENCE TO RELATED APPLICATION

This application claims the priority benefit under 35 U.S.C. § 119(e) of U.S. Provisional Application No. 63/758,575, filed on February 14, 2025, the disclosure of which is incorporated by reference in its entirety as if fully set forth herein.

### TECHNICAL FIELD

The disclosure generally relates to video processing. More particularly, the subject matter disclosed herein relates to improvements to devices and methods for synchronizing multiple displays.

### SUMMARY

There is a high demand to synchronize multiple separate displays driven either through a single display port (DP) (e.g., using a multi-stream transfer (MST) function) or multiple DP ports. Synchronized multiple displays can be of different resolutions and/or different contents, and therefore, can be rendered and sent by different display pipelines and interfaces.

In one application, when it comes to driving a very large screen, e.g., greater than 8K horizontal resolution over long distances such as Rear-seat or A-pillar to A-pillar screens in a vehicle, low-voltage differential signaling (LVDS) transmission technology cannot always accommodate the full stream bandwidth. To overcome such a deficiency, a source device such as a system on chip (SoC) may send the stream in multiple separated streams to drive a single screen that must be precisely synchronized in order to avoid tearing.

In another application, when playing the same game on multiple screens, such as in a vehicle, with different accounts logged in at the same time, or playing the same video content on multiple display screens even with different resolutions, a passenger in a back seat can see all displays, including those in the front seats, so if synchronization (or sync) is broken between them, it can be very distracting.

When transmitting videos through multiple display interfaces (e.g., MST in a single DP or multiple DPs), it may not be sufficient to only synchronize the display pipelines, in case the display interface such as DP is the primary component of video timing throughout the display topology including display panel side.

Moreover, in the case of driving multiple streams separately for a single large screen, the synchronization between streams may be much more sensitive. In such an application, the tolerance target of synchronization on the SoC side may be in the tens of pixels, and therefore, may not be addressable by the system-level architecture outside the SoC.

To overcome these types of issues, systems and methods are described herein for display synchronization. By providing a stream sync selector for each video timer in a DP, the video timers have an option to run based on the stream syncs generated by other video timers. In some embodiments, each video timer may be further configurable through a synchronization-mode control that designates one timer as a primary source of synchronization and the remaining timers as secondary synchronization receivers, thereby allowing software or firmware to select which stream provides the reference timing signal. In this manner, a stream sync signal from a single video timer may drive all video timers to ensure the multiple display streams are synchronized.

The systems and methods of the present disclosure may synchronize two or more display pipelines to generate a single stream, synchronize two or more display pipelines to generate multiple synchronized streams, synchronize two or more streams within a single DP (display port) to generate multiple synchronized MST streams, and synchronize two or more streams across two or more DPs to generate multiple synchronized streams.

In an embodiment, a method is provided for synchronizing at least two display streams comprising providing a first display pipeline for generating a first display stream, the first display pipeline coupled to a first video timer; providing at least one second display pipeline for generating at least one second display stream, the at least one second display pipeline coupled to at least one second video timer; starting the first video timer and outputting a first synchronization signal to the first display pipeline to initiate the first display stream and to the at least one second video timer; and generating, by the at least one second video timer, a second synchronization signal based on the first synchronization signal and outputting the second synchronization signal to the at least one second display pipeline to initiate the at least one second display stream and synchronize the first display stream and the at least one second display stream.

In an embodiment, a system is provided for synchronizing at least two display streams comprising a first display pipeline that generates a first display stream, the first display pipeline coupled to a first video timer; at least one second display pipeline that generates at least one second display stream, the at least one second display pipeline coupled to at least one second video timer; the first video timer outputs a first synchronization signal to the first display pipeline to initiate the first display stream and to the at least one second video timer; the second video timer outputs a second synchronization signal to the second display pipeline to initiate the second display stream and to the first video timer; and a first sync selector coupled to the first video timer and configured to receive the first and second synchronization signals and a second sync selector coupled to the second video timer and configured to receive the first and second synchronization signals, wherein the first and second sync selectors are configured to use a same one of the first or second synchronization signals to synchronize the first display stream and the at least one second display stream.

### BRIEF DESCRIPTION OF THE DRAWING

In the following section, the aspects of the subject matter disclosed herein will be described with reference to exemplary embodiments illustrated in the figures, in which:

FIG. 1 is a system for synchronizing multiple display streams, according to an embodiment.

FIG. 2 is a flowchart illustrating a method for synchronizing multiple display streams, according to an embodiment.

FIG. 3 illustrates an operation of the system shown in FIG. 1, according to an embodiment.

FIG. 4 is a system for synchronizing multiple display streams using a single display port, according to an embodiment.

FIG. 5 is a system for synchronizing multiple display streams driving a single display device, according to an embodiment.

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures(including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

As used herein, “primary” and “secondary” refer to timing-control roles between video timers, where a primary timer generates a reference synchronization signal and one or more secondary timers adjust their frame timing to that reference.

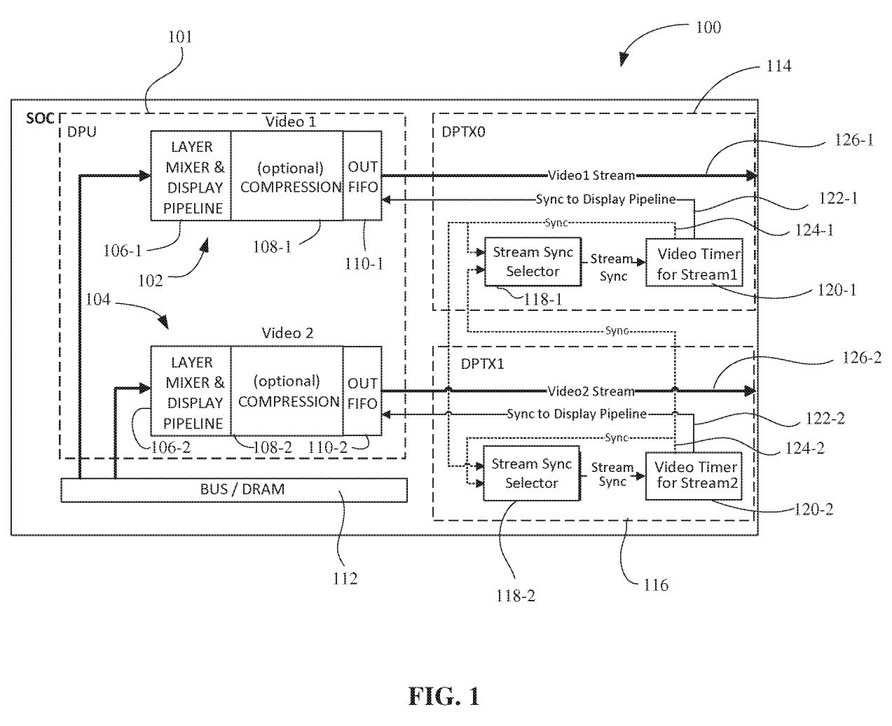

FIG. 1 is a system for synchronizing multiple display streams, according to an embodiment. Specifically, FIG. 1 depicts an example system for display synchronization.

Referring to FIG. 1, the system 100 includes a data processing unit (DPU) 101 that includes a first display pipeline 102 and a second display pipeline 104 for processing image data. Each display pipeline 102, 104 includes a layer mixer and display pipeline section 106-1, 106-2 that fetches pixel data from memory, e.g., a DRAM 112, and prepares the pixel data for output, e.g., decodes the pixel data, rotates the source image, converts pixels to RGB pixels, etc. In some embodiments, the layer mixer portion of section 106-1, 106-2 is configured to composite multiple pixel-data layers, including at least a base image layer and one or more overlay or graphics layers, into a unified display-ready frame prior to output to the subsequent pipeline stages. Each pipeline 102, 104 further includes an optional compression section 108-1, 108-2 and an output buffer memory 110-1, 110-2, e.g., a first-in-first-out (FIFO) memory. The output buffer memory 110-1, 110-2 may be implemented using any suitable buffering structure, such as a line buffer, a frame buffer, a circular buffer, a dual-port RAM, or a reserved region of system memory. The optional compression section 108-1, 108-2 may be used to reduce bandwidth before transmission, and the output FIFOs 110-1, 110-2 temporarily buffer the processed data before transfer to a display port.

In some embodiments, the system 100 further includes a first display port (DPTXO) 114 and a second display port (DPTX1) 116. Each of the first and second display ports 114, 116 include a stream sync selector 118 and a video timer 120. The video timer 120-1, 120-2 generates a first signal 122 (i.e., sync to display pipeline) that controls the outputting of the image data (i.e., Video1 Stream 126-1, Video2 Stream 126-2) from the FIFO 110-1, 110-2. The video timer 120-1, 120-2 generates a second signal 124 (i.e., sync signal) that is provided to each stream sync selector 118-1, 118-2. It is to be appreciated that the first signal 122 and second signal 124 are synchronized. The stream sync selector 118-1, 118-2 is provided for each video timer 120-1, 120-2 so the video timers 120 have an option to run based on a stream sync signal generated by other video timers. Each stream sync selector 118-1, 118-2 can be configured, for example, via a software or firmware command, to operate in a primary mode, in which its associated video timer generates and distributes a synchronization signal to other timers, or a secondary mode, in which the video timer receives and follows a synchronization signal from another timer.

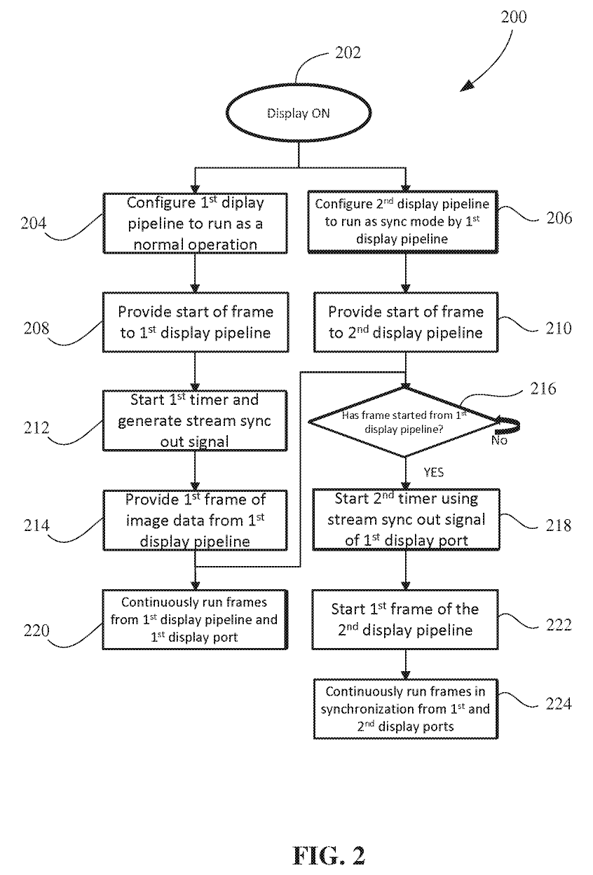

FIG. 2 is a flowchart illustrating a method for synchronizing multiple display streams, according to an embodiment.

Referring to FIG. 2, in step 202, system 100 is initialized when a display device coupled to the system 100 is turned on.

In step 204, a software function or algorithm executed by the DPU 101 configures the first display pipeline 102 to run as a normal operation, e.g., as a primary, and, in step 206, the DPU 101 configures the second display pipeline 104 to run in sync mode as controlled by the first display pipeline 102, i.e., as a salve receiver. It is to be appreciated that the display driver determines which display is primary, the display pipe that is attached to it and configures rest of the stream sync selectors to use the primary or primary’s display’s sync signal. In step 208, the DPU 101 provides a start of frame signal to the first display pipeline 102 and, in step 210, provides a start of frame signal to the second display pipeline 104. In step 212, the first display port 114 starts video timer 120-1 and generates stream sync out signal 122-1 and sync signal 124-1. In step 214, the first display pipeline 102 provides the first frame of image data via FIFO 110-1. In step 216, if the DPU 101 determines that the first frame of the first display pipeline 102 has started, the second display port 116 starts the second video timer 120-2 using the stream sync out signal 122-1 generated by the first video timer 122-1, in step 218. In other words, video timer 120-2 is triggered in direct response to the stream sync out signal 122-1, ensuring that the frame start events of both pipelines occur in precise alignment.

In step 220, the first display pipeline 102 and first display port 114 continuously run frames of the image data. In step 222, the second display pipeline 104 provides the first frame of image data via FIFO 110-2 in lock-step with the first display pipeline 102. In step 224, the second display pipeline 104 and second display port 116 continuously run frames of the image data in synchronization with the image data from the first display port 114 for all subsequent frames. The method 200 enables synchronization of multiple pipelines, ensuring that timing drift between independent ports or display streams is eliminated. The method 200 allows one pipeline to serve as a timing primary while one or more additional pipelines operate in synchronization mode, providing consistent frame alignment across separate displays, display ports, or multi-stream transport (MST) channels.

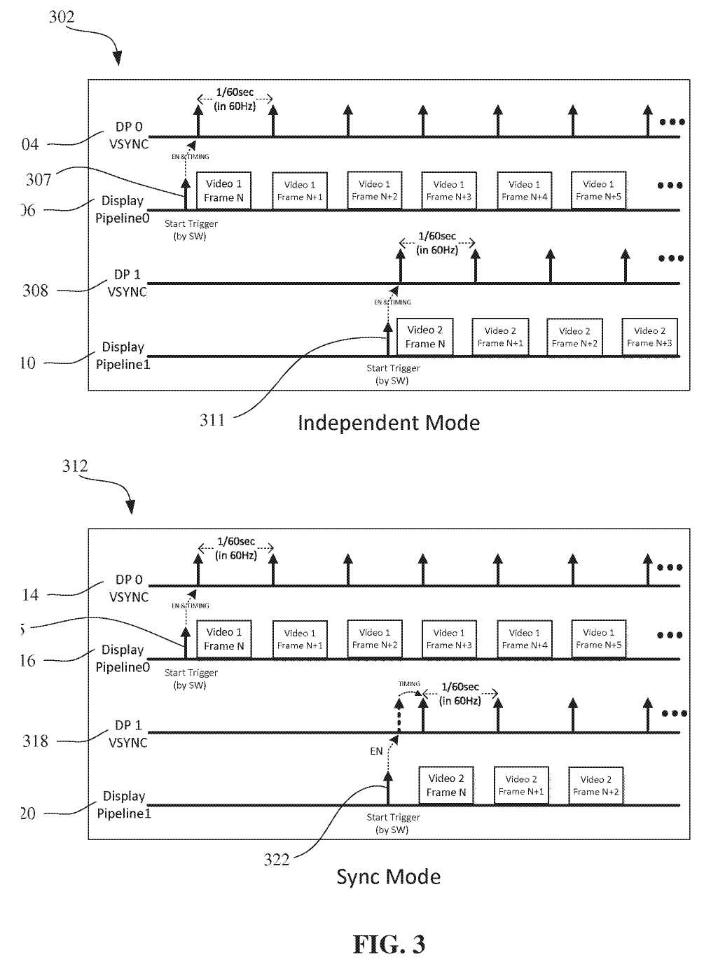

FIG. 3 illustrates example timing diagrams comparing independent operation and synchronized operation of multiple display pipelines, according to an embodiment.

Referring to FIG. 3, the operation of independent multiple display streams compared to the synchronization mode of system 100 is illustrated. Chart 302 illustrates an independent mode of operation for the first and second display pipelines 102, 104 that operate without a shared synchronization source. Chart 302 includes timing sequences for the sync signal DPO VSYNC 122-1 for the first display pipeline 102 as sequence 304, the frames of image data (i.e., Video1 Stream 126-1) for the first display pipeline 102 as sequence 306, the sync signal DP1 VSYNC 122-2 for the second display pipeline 104 as sequence 308 and the frames of image data (i.e., Video2 Stream 126-2) for the second display pipeline 104 as sequence 310. Each sync signal 304, 308 represents the start of a new frame interval, for example every 1/60 second in a 60 Hz refresh configuration. As shown in chart 302, a mismatch of sync signals (i.e., 304, 308) leads to a mismatch in frames being output to a display, i.e., compare sequence 306 to sequence 310.

In the independent mode shown in chart 302, the first display pipeline initiates its frame sequence 306 (e.g., frames N, N+1, N+2, …) in response to a trigger 307 generated by DPU 101. Separately, the second display pipeline begins its own frame sequence 310 after receiving a different trigger 311. Because these triggers are not synchronized, the start times of sync signal 304 and sync signal 308 differ, and consequently the frame boundaries of Video 1 and Video 2 are offset. This asynchronous behavior causes each display pipeline to generate frames independently, resulting in potential misalignment between displayed images across multiple displays or regions of a larger composite display, which may lead to tearing, flicker, or visually noticeable phase differences when the content is viewed simultaneously.

Chart 312 illustrates the sync mode of operation for the first and second display pipelines 102, 104 in accordance with the present disclosure. Chart 312 includes timing sequences for the sync signal DPO VSYNC 122-1 for the first display pipeline 102 as sequence 314, the frames of image data for the first display pipeline 102 as sequence 316, the sync signal DP1 VSYNC 122-2 for the second display pipeline 104 as sequence 318 and the frames of image data for the second display pipeline 104 as sequence 320. In this mode, the first display pipeline 102 and second display pipeline 104 are configured for primary–secondary synchronization such that both pipelines share a common timing reference.

The first display pipeline 102 begins its frame sequence 316 upon a trigger 315 by DPU 101. The second display pipeline 104 is configured to wait for synchronization input from first display pipeline 102 before starting. A start trigger 322 generated by DPU 101 is delayed by the arrival of the primary sync signal 314. When the synchronization condition is met, the sync signal 318 is aligned in phase with sync signal 314, causing the frame sequence 320 of the second display pipeline 104 to begin simultaneously with that of the first display pipeline 102. As shown in chart 312, by using the sync signal 314 of the first display pipeline 102 as the sync signal 318 of the second display pipeline 104, frames of image data being output to a display are synchronized between the first and second display pipelines 102, 104, i.e., compare the frames of sequence 316 to the frames of sequence 320. By deriving all subsequent sync signals from the primary, the system 100 achieves frame synchronization across multiple display outputs preventing tearing.

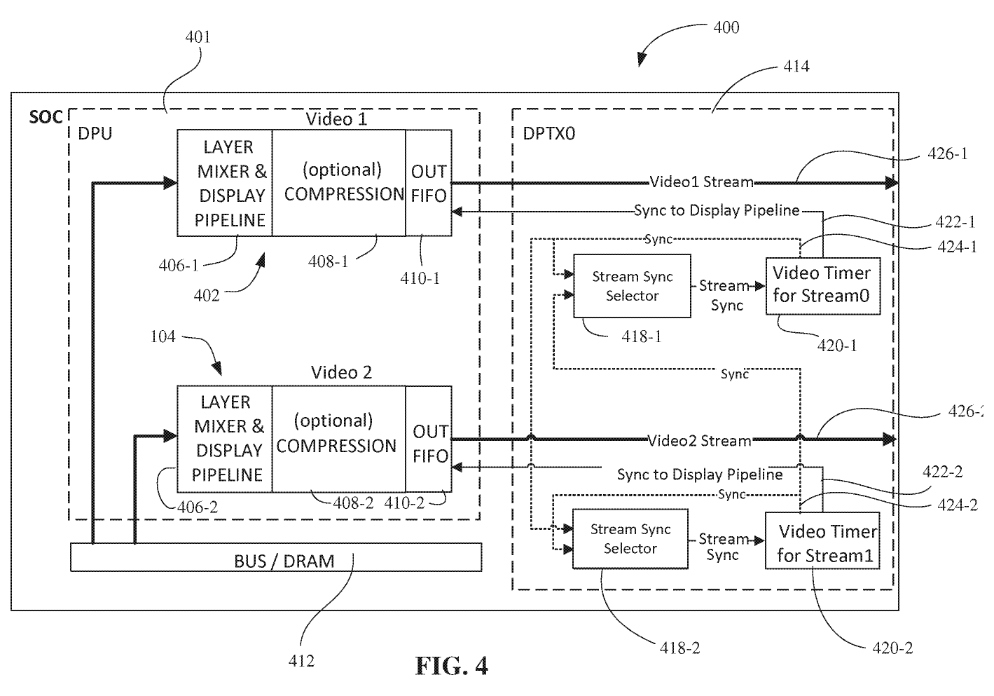

FIG. 4 illustrates a system 400 for synchronizing multiple display streams using a single display port, according to an embodiment of the present disclosure.

Referring to FIG. 4, the system 400 includes a data processing unit 401 that includes a first display pipeline 402 and a second display pipeline 404 for processing image data. Each display pipeline 402, 404 includes a layer mixer and display pipeline section 406-1, 406-2 that fetches pixel data from memory, e.g., a DRAM 412, and prepares the pixel data for output, e.g., decodes the pixel data, rotates the source image, converts pixels to RGB pixels, etc. In some embodiments, the layer mixer portion of section 406-1, 406-2 is configured to composite multiple pixel-data layers, including at least a base image layer and one or more overlay or graphics layers, into a unified display-ready frame prior to output to the subsequent pipeline stages. Each pipeline 102, 104 further includes an optional compression section 408-1, 408-2 and an output buffer memory 410-1, 410-2, e.g., a first-in-first-out (FIFO) memory. The output buffer memory 410-1, 410-2 may be implemented using any suitable buffering structure, such as a line buffer, a frame buffer, a circular buffer, a dual-port RAM, or a reserved region of system memory. The optional compression section 408-1, 408-2 may be used to reduce bandwidth before transmission, and the output FIFOs 410-1, 410-2 temporarily buffer the processed data before transfer to a display port.

In some embodiments, the system 400 further includes a single display port (DPTXO) 414. The display port 414 includes a first stream sync selector 418-1 and a first video timer 420-1 associated to the first display pipeline 402. The display port 414 further includes a second stream sync selector 418-2 and a second video timer 420-2 associated to the second display pipeline 404. The video timers 420-1, 420-2 generates a first signal 422 (i.e., sync to display pipeline) that controls the outputting of the image data (i.e., Video1 Stream 426-1, Video2 Stream 426-2) from the FIFO 410-1, 410-2. The video timer 420-1, 420-2 generates a second signal 424 (i.e., sync signal) that is provided to each stream sync selector 418-1, 418-2. It is to be appreciated that the first signal 422 and second signal 424 are synchronized. The stream sync selector 418-1, 418-2 is provided for each video timer 420-1, 420-2 so the video timers 120 have an option to run based on a stream sync signal generated by other video timers.

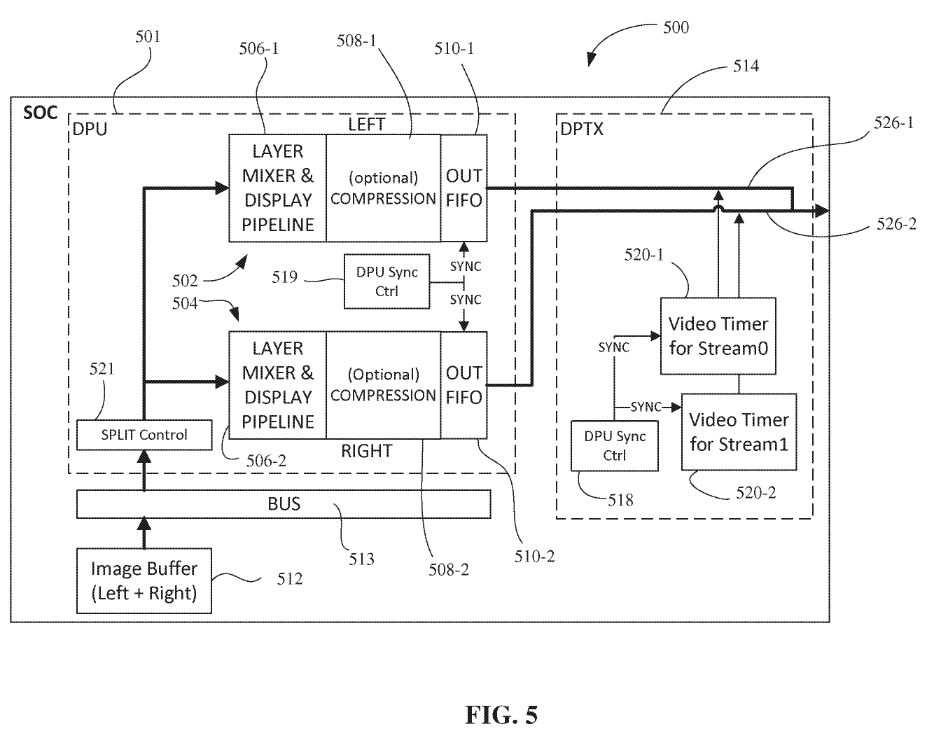

FIG. 5 illustrates a system 500 for synchronizing multiple display streams driving a single display device, according to an embodiment.

Referring to FIG. 5, the system 500 includes a data processing unit 501 that includes a first display pipeline 502 and a second display pipeline 504 for processing image data. Each display pipeline 502, 504 includes a layer mixer and display pipeline section 506-1, 506-2 that fetches pixel data from memory, e.g., a DRAM 512, and prepares the pixel data for output, e.g., decodes the pixel data, rotates the source image, converts pixels to RGB pixels, etc. In some embodiments, the layer mixer portion of section 506-1, 506-2 is configured to composite multiple pixel-data layers, including at least a base image layer and one or more overlay or graphics layers, into a unified display-ready frame prior to output to the subsequent pipeline stages. Each pipeline 502, 504 further includes an optional compression section 508-1, 508-2 and an output buffer memory 510-1, 510-2, e.g., a first-in-first-out (FIFO) memory. The output buffer memory 510-1, 510-2 may be implemented using any suitable buffering structure, such as a line buffer, a frame buffer, a circular buffer, a dual-port RAM, or a reserved region of system memory. The optional compression section 508-1, 508-2 may be used to reduce bandwidth before transmission, and the output FIFOs 510-1, 510-2 temporarily buffer the processed data before transfer to the DPTX 514.

In some embodiments, the system 500 further includes a single display port (DPTX) 514. The display port 414 includes a DP sync controller 518, a first video timer 520-1 for Stream 0 associated to the first display pipeline 502 and a second video timer 520-2 for Stream1 associated to the second display pipeline 504. A DPU sync controller 519 controls the outputting of the image data from the FIFO 510-1, 510-2.

The DPU 501 receives image data from an image buffer 512 via a system bus 513, and a split control module 521 divides the incoming image data into separate left and right portions for parallel processing, directing them respectively to the first display pipeline 502 (i.e., left-half images) and the second display pipeline 504 (i.e., right-half images). The DPU synch controller 519 ensures proper timing alignment between the two pipelines 502, 504. In this configuration, the first display pipeline 502 operates as the primary controller, while the second display pipeline 504 operates in synchronization with the first display pipeline 502. A trigger pulse is generated only during the first frame following configuration and is provided to the DPU sync controller 519. The DPU sync controller 519, upon receiving this trigger pulse, initiates synchronized operation by starting both video timers 520-1 and 520-2 simultaneously, ensuring that the left and right display pipelines remain frame-aligned. The DP sync controller 518 receives the trigger pulse from the DPU sync controller 519 and activates both video timers concurrently to maintain precise synchronization between the two output streams 526-1, 526-2. This ensures that the left and right image data streams 526-1, 526-2 are transmitted in phase, preventing visual misalignment.

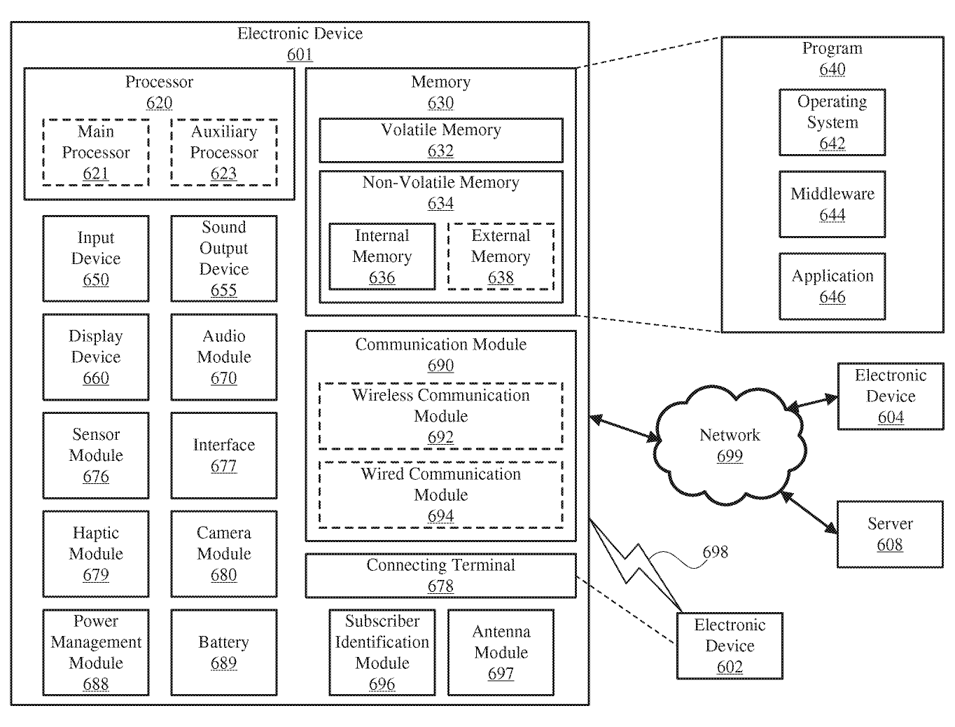

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations. For example, in some embodiments, the processor 620 performs the data processing shown in FIG. 2 for the systems 100, 400, 500 shown in FIGS. 1, 4 and 5, respectively.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high- definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH^{TM}, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination.

Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method for synchronizing at least two display streams, comprising:
providing a first display pipeline for generating a first display stream, the first display pipeline coupled to a first video timer;
providing at least one second display pipeline for generating at least one second display stream, the at least one second display pipeline coupled to at least one second video timer;
starting the first video timer and outputting a first synchronization signal to the first display pipeline to initiate the first display stream and to the at least one second video timer; and
generating, by the at least one second video timer, a second synchronization signal based on the first synchronization signal and outputting the second synchronization signal to the at least one second display pipeline to initiate the at least one second display stream and synchronize the first display stream and the at least one second display stream.

2. The method of claim 1, wherein the synchronized first display stream and the at least one second display stream is a single stream.

3. The method of claim 2, further comprising:
reading, by the first display pipeline, left half images from a buffer;
reading, by the at least one second display pipeline, right half images from the buffer; and
outputting the synchronized first display stream and the at least one second display stream to a single display device.

4. The method of claim 1, wherein the first video timer and the at least one second video timer are disposed on a single display port, further comprising outputting the synchronized first display stream and the at least one second display stream via a multi-stream transfer (MST) function.

5. The method of claim 1, wherein the first video timer is disposed on a first display port and the at least one second video timer is disposed on a second display port, further comprising outputting the first display stream to a first display device and outputting the at least one second display stream to a second display device.

6. The method of claim 1, wherein the starting of the first video timer is initiated by a trigger generated by a data processing unit, the trigger being transmitted simultaneously to the first and the at least one second video timer to initiate synchronized frame output.

7. The method of claim 1, further comprising configuring each video timer with a selectable synchronization mode, wherein the selectable synchronization mode designates one video timer as a primary source of synchronization and designates the remaining video timers as secondary synchronization receivers.

8. A system for synchronizing at least two display streams comprising:
a first display pipeline that generates a first display stream, the first display pipeline coupled to a first video timer;
at least one second display pipeline that generates at least one second display stream, the at least one second display pipeline coupled to at least one second video timer;
the first video timer outputs a first synchronization signal to the first display pipeline to initiate the first display stream and to the at least one second video timer;
the second video timer outputs a second synchronization signal to the second display pipeline to initiate the second display stream and to the first video timer; and
a first sync selector coupled to the first video timer and configured to receive the first and second synchronization signals and a second sync selector coupled to the second video timer and configured to receive the first and second synchronization signals,
wherein the first and second sync selectors are configured to use a same one of the first or second synchronization signals to synchronize the first display stream and the at least one second display stream.

9. The system of claim 8, wherein the first display pipeline includes a first first-in-first-out (FIFO) buffer for outputting the first display stream and the second display pipeline includes a second FIFO buffer for outputting the second display stream.

10. The system of claim 8, wherein the synchronized first display stream and the at least one second display stream is a single stream.

11. The system of claim 9, further comprising:
a memory that stores left half images and right half images;
the first display pipeline reads the left half images from the memory and the at least one second display pipeline reads the right half images from the memory;
wherein the synchronized first display stream and the at least one second display stream are output to a single display device.

12. The system of claim 8, wherein the first video timer and the at least one second video timer are disposed on a single display port, the single display port outputs the synchronized first display stream and the at least one second display stream via a multi-stream transfer (MST) function.

13. The system of claim 8, wherein the first video timer is disposed on a first display port and the at least one second video timer is disposed on a second display port, the first display port outputs the first display stream to a first display device and the second display port outputs the at least one second display stream to a second display device.

14. The system of claim 8, wherein a data processing unit (DPU) is configured to generate a trigger signal to simultaneously start the first video timer and the at least one second video timer, the trigger signal initiating synchronized operation of the corresponding display pipelines.

15. The system of claim 8, wherein each video timer includes a synchronization-mode control configured to designate one of the video timers as a primary source of synchronization and to designate at least one other video timer as a secondary synchronization receiver, each synchronization-mode control being coupled to a corresponding stream sync selector that selects which synchronization signal to follow.

16. A non-transitory computer-readable medium storing instructions, when executed by a processing device, cause the processing device to perform the steps of:
generating a first display stream via a first display pipeline, the first display pipeline coupled to a first video timer, the first video timer outputs a first synchronization signal to the first display pipeline to initiate the first display stream and to at least one second video timer;
generating at least one second display stream via at least one second display pipeline, the at least one second display pipeline coupled to the at least one second video timer, the second video timer outputs a second synchronization signal to the second display pipeline to initiate the second display stream and to the first video timer; and
selecting a same one of the first or second synchronization signals to drive the first and second display pipelines and synchronize the first display stream and the at least one second display stream.

17. The non-transitory computer-readable medium of claim 16, wherein the instructions, when executed by the processing device, further cause the processing device to output the synchronized first display stream and the at least one second display stream is a single stream.

18. The non-transitory computer-readable medium of claim 16, wherein the instructions, when executed by the processing device, further cause the processing device to
read left half images from a buffer;
read right half images from the buffer; and
output the synchronized first display stream and the at least one second display stream to a single display device.

19. The non-transitory computer-readable medium of claim 16, wherein the instructions, when executed by the processing device, further cause the processing device to output the synchronized first display stream and the at least one second display stream via a multi-stream transfer (MST) function.

20. The non-transitory computer-readable medium of claim 16, wherein the instructions, when executed by the processing device, further cause the processing device to generate a trigger to initiate the starting of the first video timer, the trigger being transmitted simultaneously to the first and the at least one second video timer to initiate synchronized frame output.

21. The non-transitory computer-readable medium of claim 16, wherein the instructions, when executed by the processing device, further cause the processing device to configure each video timer with a selectable synchronization mode, wherein the selectable synchronization mode designates one video timer as a primary source of synchronization and designates the remaining video timers as secondary synchronization receivers.
